(19) United States
(12) Patent Application Publication
(10) Pub. No.: US 2019/0121759 A1
(43) Pub. Date: Apr. 25, 2019

(54) METHOD TO EXTEND SERVER RMC AND MIDDLE PLANE COMMUNICATION COMMAND

(71) Applicant: ZHENGZHOU YUNHAI INFORMATION TECHNOLOGY CO., LTD., Zhengzhou, Henan (CN)

(72) Inventor: Yanbin GONG, Zhengzhou, Henan (CN)

(73) Assignee: ZHENGZHOU YUNHAI INFORMATION TECHNOLOGY CO., LTD., Zhengzhou, Henan (CN)

(21) Appl. No.: 16/096,961

(22) PCT Filed: Jul. 20, 2017
(86) PCT No.: PCT/CN2017/093683

§ 371 Date: Oct. 26, 2018

(30) Foreign Application Priority Data
Oct. 25, 2016 (CN) 201610936914.8

(51) Int. Cl. G06F 13/20; G06F 13/42

(52) U.S. Cl. CPC G06F 13/20; G06F 2213/0016; G06F 13/4282

(57) ABSTRACT

A method for extending a communication command between a server RMC and a middle plane is provided, including: defining, based on determination made on received byte in an I2C receiving interrupt, a primary command word and a secondary command word; receiving, in the I2C receiving interrupt, the first-received byte, and determining, by using the primary command, a secondary command target; receiving, in the I2C receive interrupt, the second-received byte; calling a primary command dispatching function, to dispatch the command to a secondary command dispatching function; and adding, by the secondary command dispatching function, instructions to different command queues to perform different functions.

### FIELD

The present disclosure relates to the field of internal communication control of a server, and in particular, to a method for communicating a secondary command between a server cabinet RMC and a middle plane.

### BACKGROUND

With development of new technologies such as cloud computing and big data, there is an increasing demand for cabinet servers, and increasing packaged customization on SmartRack cabinets for customers. With the increasing demand of customers on customization of server RMC monitoring, communication between a RMC and a middle plane is more and more complicated, resulting in more and more command words. With a demand on the RMC being compatible with different node types, such as Sas_Switch, Jbod, GPUBOX, Server, and the like, it is required that a communication protocol between the RMC and each type of node via the middle plane is separately customized. Thereby, more command words between the RMC and the middle plane are required to meet requirements of the complicated communication.

### TECHNICAL PROBLEM

In order to address the above issue, a method for extending, based on I2C communication interrupt processing, a communication command between a server RMC and a middle plane is provided according to the present disclosure, which has advantages of good compatibility and extendibility.

### SOLUTION TO PROBLEM

### Technical Solution

In order to achieve the above objective, following technical solutions are adopted according to the present disclosure.

A method for extending a communication command between a server RMC and a middle plane includes:

A: defining, based on determination made on a received byte in an I2C receiving interrupt, a primary command word and a secondary command word, where a first-received byte is the primary command word, and a second-received byte is the secondary command word;

B: receiving, in an I2C receiving interrupt, the first-received byte, and determining, by using the primary command word, a secondary command target;

C: receiving, in an I2C receive interrupt, the second-received byte;

D: calling a primary command dispatching function to dispatch the command to a secondary command dispatching function; and

E: adding, by the secondary command dispatching function, a corresponding instruction to a command queue to perform a function.

### BENEFICIAL EFFECT OF SOLUTION

### Beneficial Effect

Beneficial effects according to the present disclosure includes that communication command words between the RMC and the middle plane are greatly extended, which solve a bottleneck of limited quantity of the command words, and thus facilitates more complicated communication between the RMC and the middle plane and supports monitoring of more kinds of device.

For the communication between the RMC and the middle plane, the primary command word and the secondary command word between the middle plane and the RMC are defined based on the determination on the received bytes in the I2C reception interrupt, and then the commands are added, via the command distribution functions, into the different command queues to perform the different functions.

Additionally, in an aspect of compatibility, according to present disclosure, the corresponding secondary command is added on the basis of an original 16-bit command word for communication between the RMC and the middle plane, and is customized for communication between the RMC and the middle plane, Thereby, not only adding the secondary command, but also achieving compatibility with a previous version of a communication word of the RMC.

### BRIEF DESCRIPTION OF THE DRAWINGS

### Drawing Description

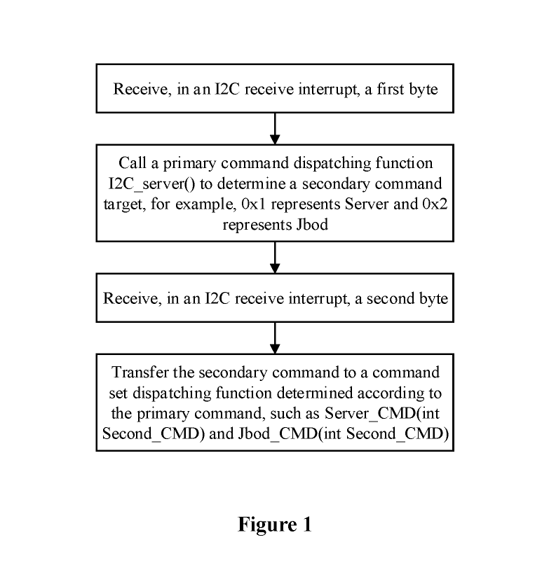

FIG. 1 is a flow chart of a process for extending a secondary command word of I2C communication.

### DETAILED DESCRIPTION

### Embodiments

Hereinafter the technical solution is further illustrated with reference to the drawings and embodiments.

As shown in FIG. 1, a middle plane FW supporting the extending of the secondary command is transmitted into a RMC FW which is customized to support the secondary command. In an I2C receive interrupt, the first byte is received, and a primary command dispatching function I2C_server( )is called to determine a secondary command target. For example, 0×1 represents Server and 0×2 represents Jbod. In the I2C receive interrupt, the second byte is received. The secondary command is transferred to a command set dispatching function determined according to the primary command, such as Server_CMD(int Second_CMD) and Jbod_CMD(int Second_CMD).

Specific embodiments of the present disclosure, although described hereinabove in conjunction with the drawings, do not limit the protection scope of the present disclosure. Those skilled in the art should understand that various modifications or variations, which can be made without creative efforts by those skilled in the art on the basis of the technical solutions of the present disclosure without, falls within the protection scope of the present disclosure.

1. A method for extending a communication command between a server RMC and a middle plane, comprising:
A: defining, based on determination made on received byte in an I2C receiving interrupt, a primary command word and a secondary command word, wherein a first-received byte is the primary command word, and a second-received byte is the secondary command word;
B: receiving, in the I2C receiving interrupt, the first-received byte, and determining, by using the primary command word, a secondary command target;
C: receiving, in the I2C receive interrupt, the second-received byte;
D: calling a primary command dispatching function, to dispatch the command to a secondary command dispatching function; and
E: adding, by the secondary command dispatching function, a corresponding instruction to a command queue to perform a function.
